(19) United States
(12) Patent Application Publication
(10) Pub. No.: US 2025/0223673 A1
(43) Pub. Date: Jul. 10, 2025

(54) DIAMOND TIPPED CUTTING TOOL

(71) Applicant: JAMES KANG, Las Vegas, NV (US)

(72) Inventor: JAMES KANG, Las Vegas, NV (US)

(21) Appl. No.: 18/406,510

(22) Filed: Jan. 8, 2024

(51) Int. Cl. C22C 26/00; B26B 9/00; C22C 1/10; C22C 1/11; C22C 5/02; C22C 5/04; C22C 30/02; C22C 38/00; C22C 38/02; C22C 38/44; C22C 38/54; C22C 45/00; C22C 45/10

(52) U.S. Cl. CPC C22C 26/00; B26B 9/00; C22C 1/10; C22C 1/11; C22C 5/02; C22C 5/04; C22C 30/02; C22C 38/002; C22C 38/02; C22C 38/44; C22C 38/54; C22C 45/00; C22C 45/003; C22C 45/008; C22C 45/10; C22C 2200/02

(57) ABSTRACT

Embodiments relate to a cutting tool comprising a base material, an amorphous alloy forming an amorphous alloy matrix layer; and a plurality of diamond particles embedded in the amorphous alloy matrix layer forming a cutting edge, wherein the amorphous alloy matrix layer bonds the plurality of diamond particles and the base material.

### FIELD OF INVENTION

This disclosure generally relates to cutting tools. More particularly, the present embodiments relate to cutting tools having an edge formed from diamond particles with an amorphous material as a bonding matrix.

### BACKGROUND

In this section prior art is cited:

“Although sharp-edged cutting tools are produced from a variety of materials, each has significant disadvantages. For example, sharp-edged cutting tools are produced from hard materials such as carbides, sapphire and diamonds that provide sharp and effective cutting edges; however, these materials have a substantially higher manufacturing cost. In addition, cutting edges of blades made from these materials are extremely fragile due to the materials intrinsically low toughness.” [U.S. Application Publication US20180029241A1, titled “Method of forming cutting tools with amorphous alloys on an edge thereof”]

“When a composite material of this type is used as a cutting tool, the surface regions of the metal matrix quickly wear away to expose the pieces of the hard, abrasive material. This exposed region acts as the cutting instrument, in as much as it is hard, abrasive, durable, and resistant to wear during the cutting operation. However, the underlying metal matrix which bonds the hard, abrasive material can wear away or crack with extended use and/or exposure to corrosive media. These problems are particularly troubling for those cases where there are reaction products in the matrix or the matrix was chosen to be relatively soft and weak in order to avoid the presence of reaction products. In these cases, the cutting tool may prematurely fail as the matrix material is removed or damaged, and the bonded abrasive material is undermined.” [U.S. Application Publication U.S. Pat. No. 5,866,254A, titled “Amorphous metal/reinforcement composite material”]

Therefore, there is a need for an improved bonding matrix for forming a cutting blade with embedded particles where there is no premature loss of the embedded particles due to failure of bonding matrix or loosening of diamond particles from the wear of bonding matrix.

### SUMMARY

The following is a summary to provide a basic understanding of one or more embodiments described herein. This summary is not intended to identify key or critical elements or delineate any scope of the different embodiments and/or any scope of the claims. The sole purpose of the summary is to present some concepts in a simplified form as a prelude to the more detailed description presented herein.

According to an embodiment, it is a method, comprising, considering a base material in a predetermined shape comprising a first portion and a second portion; forming a groove on the first portion to form a cutting edge; applying an amorphous alloy material in the groove of the first portion to form an amorphous alloy matrix layer; placing a plurality of diamond particles on the amorphous alloy matrix layer; heating the amorphous alloy matrix layer until it reaches a predefined temperature; and applying pressure over the first portion such that the first portion, the plurality of diamond particles, and the amorphous alloy matrix layer are bonded together, and wherein the plurality of diamond particles protrude above the amorphous alloy matrix layer to a uniform height; and consolidating the amorphous alloy matrix layer such that the plurality of diamond particles is held in the amorphous alloy matrix layer and the amorphous alloy matrix layer is attached to the second portion; and wherein the amorphous alloy matrix layer is at least 300 micrometers (microns) in thickness; and wherein the method is operable for making the cutting tool comprising the plurality of diamond particles forming the cutting edge.

According to an embodiment of the method, the predefined temperature is in a range of 400° C. to 500° C.

According to an embodiment of the method, the amorphous alloy matrix layer is 5 to 10 times more wear resistant than a silver brazing alloy.

According to an embodiment of the method, the base material, the plurality of diamond particles, and the amorphous alloy matrix layer experience an elevated temperature in a range of 400° C. to 500° C. for less than 60 seconds.

According to an embodiment of the method, the plurality of diamond particles is pre-sharpened

According to an embodiment of the method, the plurality of diamond particles is of a size ranging from 0.002 mm to 0.02 mm.

According to an embodiment of the method, the plurality of diamond particles is laid flat on a first side and pressed from a second side so that a sharp edge is oriented in a vertical position to form the cutting edge.

According to an embodiment of the method, the base material comprises at least one of steel, aluminum, and an alloy.

According to an embodiment of the method, the cutting tool is a knife.

According to an embodiment of the method, the second portion is machined to form a shape of the knife.

According to an embodiment of the method, the knife further comprises a handle portion secured to the knife portion, wherein the handle portion is made from a non-slip material comprising textured polymer.

According to an embodiment of the method, the plurality of diamond particles is arranged in a predetermined pattern on the amorphous alloy matrix layer.

According to an embodiment of the method, the predetermined pattern comprises a position and orientation of an edge of each diamond particle of the plurality of diamond particles and a separation between any two diamond particles of the plurality of diamond particles.

According to an embodiment of the method, a layer of adhesive is used to keep the plurality of diamond particles in place on the amorphous alloy matrix layer.

According to an embodiment of the method, the plurality of diamond particles protrude above the amorphous alloy matrix layer to form a serrated cutting edge.

According to an embodiment of the method, wherein the handle is foldable allowing a blade portion of the cutting tool to be securely enclosed within the handle.

According to an embodiment of the method, a fusing of the amorphous alloy matrix layer to the second portion comprises heating the amorphous alloy matrix layer to a predefined temperature in a range of 400° C. to 500° C.

According to an embodiment of the method, the amorphous alloy material comprises silica or silica based glass sheets.

According to an embodiment of the method, the amorphous alloy material comprises iron based amorphous ribbons.

According to an embodiment of the method, the iron based amorphous ribbons comprise iron in a first range of 84-100%, silicon in a second range of 0-10%, boron in a third range of 0-5%, and manganese in a fourth range of 0-2%.

According to an embodiment of the method, the iron based amorphous ribbons comprise iron in a first range of 0-100%, cobalt in a second range of 0-85%, Nickel in a third range of 0-50%, silicon in a fourth range of 0-10%, molybdenum in a fifth range of 0-8%, boron in a sixth range of 0-5%, and manganese in a seventh range of 0-2%.

According to an embodiment of the method, the amorphous alloy material comprises an amorphous alloy that has an elastic strain limit of at least 1.5% selected from (Zr,Ti)ₐ(Ni,Cu,Fe)_{b}(Be,Al,Si,B)_{c} wherein a=30-75; b=5-60 & c=0-50 atomic percentages; (Zr,Ti)ₐ(Ni,Cu)_{b}(Be)_{c} wherein a=40-75; b=5-50; & c=5-50 in atomic percentages; (Zr,Ti)ₐ(Ni,Cu)_{b}(Be)_{c} wherein a=40-65; b=7.5-35; & c=10-37.5 in atomic percentages; and (Zr)ₐ(Nb,Ti)_{b}(Ni,Cu)_{c}(Al)_{d} and wherein a=45-65; b=0-10; c=20-40; & d=7.5-15.

According to an embodiment of the method, the amorphous alloy material comprises a Zr-based, a Ti-based, a Zr—Ti-based, an Fe-based, or combinations thereof, amorphous alloy.

According to an embodiment of the method, the amorphous alloy material is at least substantially free of Be.

According to an embodiment of the method, the amorphous alloy material further comprises a plurality of crystalline precipitates.

According to an embodiment of the method, the amorphous alloy matrix layer comprises a composite material having 50% by volume of amorphous material.

According to an embodiment of the method, the plurality of diamond particles are lightly bonded to the amorphous alloy and held in place with an evaporative glue.

According to an embodiment, it is a device comprising, a base material; an amorphous alloy forming an amorphous alloy matrix layer; and a plurality of diamond particles embedded in the amorphous alloy matrix layer forming a cutting edge, wherein the amorphous alloy matrix layer bonds the plurality of diamond particles and the base material; and wherein the amorphous alloy matrix layer is at least 300 microns in thickness; and wherein the device is operable as a cutting tool.

According to an embodiment of the device, the cutting tool is a knife.

According to an embodiment of the device, the plurality of diamond particles is pre-sharpened.

According to an embodiment of the device, the plurality of diamond particles is of a size ranging from 0.002 mm to 0.02 mm.

According to an embodiment of the device, the plurality of diamond particles is operable to form a serrated edge of the cutting edge.

According to an embodiment of the device, a handle for the device is comprising at least one of a steel, aluminum, and plastic.

According to an embodiment, it is a method comprising, casting a blade portion of a cutting tool using a metal or a ceramic; and fusing an amorphous alloy material to an edge of the blade portion using a hot forming process; and wherein a cutting edge area comprises at least 50% by volume of the amorphous alloy material and a thickness of the amorphous alloy material on the edge is at least 300 microns.

According to an embodiment of the method, the hot forming process is a hot pressing process.

According to an embodiment of the method, the cutting edge area comprises diamond particles.

### BRIEF DESCRIPTION OF THE FIGURES

Aspects of the present invention will now be described in more detail, with reference to the appended drawings showing exemplary embodiments of the present invention, in which:

FIG. 1 shows a hardness chart for various materials according to an embodiment.

FIG. 2 shows mechanically bonded diamond particles in a base using a bonding matrix according to an embodiment.

FIG. 3 shows a step in the making of a diamond cutting tool with amorphous alloy as a matrix according to an embodiment.

FIG. 4 shows pre-sharpened diamond particles arranged on an amorphous alloy according to an embodiment.

FIG. 5 shows a serrated edge of a shark's tooth according to an embodiment.

FIG. 6 shows a serrated edge of a prior art knife according to an embodiment.

FIG. 7 shows a serrated edge of a prior art knife according to an embodiment.

FIG. 8 shows a flowchart of a process for making a diamond tipped cutting tool according to an embodiment.

FIG. 9 shows an example of compositions of amorphous alloys according to an embodiment.

FIG. 10 shows an additional example of compositions of amorphous alloys according to an embodiment.

### DETAILED DESCRIPTION

### Definitions and General Techniques

For simplicity and clarity of illustration, the figures illustrate the general manner of construction. The description and figures may omit the descriptions and details of well-known features and techniques to avoid unnecessarily obscuring the present disclosure. The figures exaggerate the dimensions of some of the elements relative to other elements to help improve understanding of embodiments of the present disclosure. The same reference numeral in different figures denotes the same element.

Although the detailed description herein contains many specifics for the purpose of illustration, a person of ordinary skill in the art will appreciate that many variations and alterations to the details are considered to be included herein.

Accordingly, the embodiments herein are without any loss of generality to, and without imposing limitations upon, any claims set forth. The terminology used herein is for the purpose of describing particular embodiments only and is not limiting. Unless defined otherwise, all technical and scientific terms used herein have the same meaning as commonly understood by one with ordinary skill in the art to which this disclosure belongs.

Other specific forms may embody the present invention without departing from its spirit or characteristics. The described embodiments are in all respects illustrative and not restrictive. Therefore, the appended claims rather than the description herein indicate the scope of the invention. All variations which come within the meaning and range of equivalency of the claims are within their scope.

While this specification contains many specifics, these do not construe as limitations on the scope of the disclosure or of the claims, but as descriptions of features specific to particular implementations. A single implementation may implement certain features described in this specification in the context of separate implementations. Conversely, multiple implementations separately or in any suitable sub-combination may implement various features described herein in the context of a single implementation. Moreover, although features described herein are acting in certain combinations and even initially claimed as such, one or more features from a claimed combination may in some cases be excised from the combination, and the claimed combination may be directed to a sub-combination or variation of a sub-combination.

Similarly, while operations depicted herein in the drawings in a particular order to achieve desired results, this should not be understood as requiring that such operations be performed in the particular order shown or in sequential order or that all illustrated operations be performed to achieve desirable results. In certain circumstances, multitasking and parallel processing may be advantageous. Moreover, the separation of various system components in the implementations should not be understood as requiring such separation in all implementations, and it should be understood that the described program components and systems may be integrated together in a single software product or packaged into multiple software products.

Even though particular combinations of features are recited in the claims and/or disclosed in the specification, these combinations are not intended to limit the disclosure of possible implementations. Other implementations are within the scope of the claims. For example, the actions recited in the claims may be performed in a different order and still achieve desirable results. In fact, many of these features may be combined in ways not specifically recited in the claims and/or disclosed in the specification. Although each dependent claim may directly depend on only one claim, the disclosure of possible implementations includes each dependent claim in combination with every other claim in the claim set.

The present disclosure may be embodied in other specific forms without departing from its spirit or characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

Unless otherwise defined herein, scientific, and technical terms used in connection with the present disclosure shall have meanings that are commonly understood by those of ordinary skill in the art. Further, unless otherwise required by context, singular terms shall include pluralities and plural terms shall include the singular.

The following terms and phrases, unless otherwise indicated, shall be understood to have the following meanings.

As used herein, the articles “a” and “an” used herein refer to one or to more than one (i.e., to at least one) of the grammatical object of the article. By way of example, “an element” means one element or more than one element. Moreover, usage of articles “a” and “an” in the subject specification and annexed drawings construe to mean “one or more” unless specified otherwise or clear from context to mean a singular form.

As used herein, the terms “example” and/or “exemplary” mean serving as an example, instance, or illustration. For the avoidance of doubt, such examples do not limit the herein described subject matter. In addition, any aspect or design described herein as an “example” and/or “exemplary” is not necessarily preferred or advantageous over other aspects or designs, nor does it preclude equivalent exemplary structures and techniques known to those of ordinary skill in the art.

As used herein, the terms “first,” “second,” “third,” and the like in the description and in the claims, if any, distinguish between similar elements and do not necessarily describe a particular sequence or chronological order. The terms are interchangeable under appropriate circumstances such that the embodiments herein are, for example, capable of operation in sequences other than those illustrated or otherwise described herein. Furthermore, the terms “include”, “have”, and any variations thereof, cover a non-exclusive inclusion such that a process, method, system, article, device, or apparatus that comprises a list of elements is not necessarily limiting to those elements, but may include other elements not expressly listed or inherent to such process, method, system, article, device, or apparatus.

No element act, or instruction used herein is critical or essential unless explicitly described as such. Furthermore, the term “set” includes items (e.g., related items, unrelated items, a combination of related items and unrelated items, etc.) and may be interchangeable with “one or more”. Where only one item is intended, the term “one” or similar language is used. Also, the terms “has,” “have,” “having,” or the like are open-ended terms. Further, the phrase “based on” means “based, at least in part, on” unless explicitly stated otherwise.

As used herein, the terms “system,” “device,” “unit,” and/or “module” refer to a different component, component portion, or component of the various levels of the order. However, other expressions that achieve the same purpose may replace the terms.

As used herein, the term “or” means an inclusive “or” rather than an exclusive “or.” That is, unless specified otherwise, or clear from context, “X uses A or B” means any of the natural inclusive permutations. That is, if X uses A; X uses B; or X uses both A and B, then “X uses A or B” is satisfied under any of the foregoing instances.

As used herein, the term “approximately” can mean within a specified or unspecified range of the specified or unspecified stated value. In some embodiments, “approximately” can mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

The term “cutting tool” as used herein refers to an instrument designed for the purpose of severing, slicing, piercing, and/or cutting through materials for controlled removal of material.

The term “matrix” as used herein refers to the material in which another substance, such as metal, is embedded or dispersed. Matrix material generally refers to the substance that surrounds, supports, or encapsulates another material or phase within a composite structure. In various fields, the term may be used to describe the continuous phase in a composite material where the primary component or reinforcement is embedded. In composite materials, the matrix is the material that binds and supports reinforcement (such as fibers or particles). In abrasive tools like grinding wheels, the matrix material is the substance that binds together with the abrasive particles (such as alumina or silicon carbide). The matrix material provides cohesion and strength to the grinding wheel. In ceramics, the matrix material is the main component that binds together the ceramic particles.

Other aspects, features, and advantages of the present invention will become apparent from the following detailed description, the accompanying drawings, and the appended claims.

All publications, patents, and patent applications cited in this specification are hereby incorporated by reference in their entirety.

Global premium knife market size is around $4 billion. 95% of these knives are made of High Strength Steel. 75% of these knives are never sharpened. Steel knives get dull within a few months of daily use. Most consumers have drawers full of dull and rusting knives.

Despite living in an era of space exploration and advanced materials, it's worth questioning whether we can surpass the achievements from 700 years ago.

Absolute hardness and wear resistance of diamonds have been well established. On average, a diamond edge is estimated to outlast steel by 500 to 1000 times. Nevertheless, the complexities associated with working with diamonds have restricted the application of diamond cutting tools primarily to high-value medical and industrial purposes.

Objective of diamond cutlery: Much like the revolutionary impact of Bessemer Steel and Plastics, Liquidmetal®/diamond cutting tools have the potential to transform the cost/performance landscape, achieving a 100× improvement by providing nearly permanent edge durability at an affordable price.

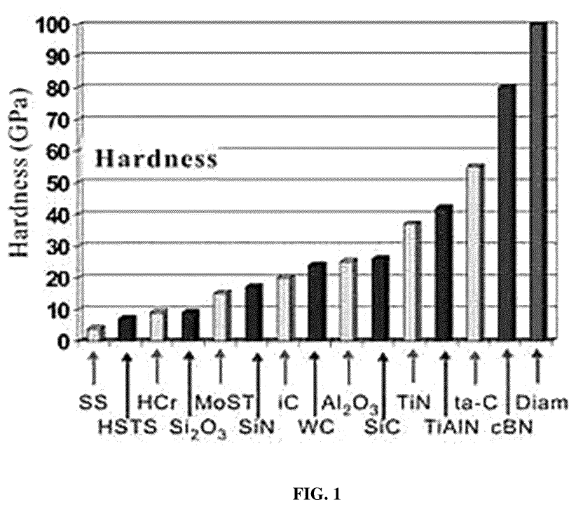

FIG. 1 shows a hardness chart for various materials according to an embodiment. As shown in FIG. 1, High Strength Steel is at the far left and Diamond is at the far right. A technology that can capture the performance of diamond knives at consumer-friendly price points can disrupt the current knife market. The current situation prompts the question, “Why are there no cost-effective diamond knives available?”

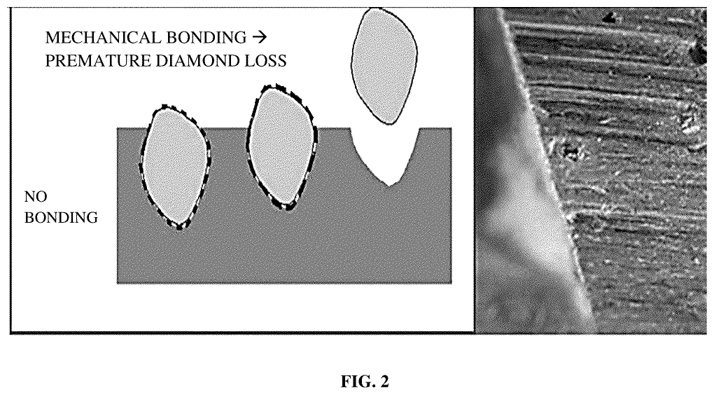

Importance of Matrix: Diamonds are so hard; they cannot be worn down from cutting meat and vegetables. However, Diamond composites wear down as the bonding matrix wears down and loses its grip on the diamond particles. For most applications, the matrix determines the feasibility and durability of the diamond composite structures. FIG. 2 shows mechanically bonded diamond particles in a base using a bonding matrix according to an embodiment, where a diamond particle falls off prematurely from the matrix.

Majority of the bonding relies on brazing using brazing alloys. Brazing is a metal-joining process in which two or more materials are joined together by melting and flowing a filler metal into the joint. Unlike welding, brazing does not involve melting the base metals being joined. Instead, it relies on the melting of a lower-melting-point filler metal, known as brazing alloy or braze, to create a strong and durable bond between the materials. Brazing alloys, varying in composition with some being silver-based or even incorporating gold, typically feature low melting points. Most diamond brazing alloys necessitate a vacuum bonding process, making them costly. These alloys are designed for low temperature melting, prioritizing ease of bonding over exceptionally high strength. Diamonds themselves are inherently hard and do not wear down easily, even when in contact with grinding stones or steels. The primary wear mechanism for diamond blades and abrasives, as illustrated in FIG. 2, involves the surrounding material loosening, akin to the gum around teeth, leading to diamond detachment. This phenomenon significantly impacts the lifespan of these tools. In terms of strength, the Liquidmetal® (amorphous alloy) boasts a tensile strength of around 250 ksi (kilo-pound per square inch, 1 ksi=1000 psi), while many brazing alloys fall within the 40 to 60 ksi range. This order of magnitude difference in strength positions Liquidmetal® for a much stronger grip on the material, resulting in slower wear compared to abrasives. Consequently, a prolonged and durable performance is anticipated surpassing the wear rate of traditional abrasive tools.

Brazing forms a mechanical bond rather than a chemical bond. It conforms to the given shapes, securing itself in whatever space is available. The liquid metal flows into and grips onto the provided surfaces, remaining in place. This allows for versatility in the materials used, as long as they can withstand temperatures of around 500 degrees.

Challenges of Metallic Matrix: (i) Diamond begins to burn above 700 degrees centigrade. Since steel melts above 1300 degrees centigrade, low temperature brazing alloys (often silver or gold based) are required to bond diamonds to its steel base. Brazing is a joining process used to bond two or more materials together by melting and flowing a filler metal into the joint. Unlike welding, where the base metals themselves are melted, in brazing, the base metals remain solid. The filler metal used in brazing has a lower melting point than the base metals. However, most brazing alloys require temperatures in the range of 800 degrees centigrade or more. Since diamonds begin to oxidize above 700 degrees centigrade, vacuum brazing chambers are required. The vacuum requirement increases costs dramatically.
(ii) Steel frames cannot endure brazing procedure. In addition, the steel used to form the base, and keep the sharp-edge geometry, loses approximately 50%-70% of its hardness when subjected to hours of elevated temperature in a brazing chamber. When the base carbon steel loses approximately 50% of its hardness, it is no longer capable of holding a thin cross section, required for cutting instruments/cutting tools.

Challenges of Sharpening Diamonds: Diamonds are challenging to sharpen. The extreme hardness of diamond particles also adds significantly to the initial cost. Plasma and other techniques are being developed to avoid the physical grind and sharpen step. These challenges all contribute to the high cost of diamond cutting tools.

Advantages of Amorphous Alloy (Liquidmetal®) Matrix:
(i) Low Forming Temperature-Liquidmetal® (LM) begins to soften around 400 degrees centigrade well below its liquidus temperature of near 760 degrees centigrade. Further, as demonstrated by Omega® watch production, LM can be hot formed into detailed features. The ideal temperature to hot form Liquidmetal® is between 400 degrees centigrade to 500 degrees centigrade, which is 250 degrees centigrade below the temperature where diamonds begin to oxidize. Also, the time required where the base steel, Liquidmetal®, and diamonds experience elevated temperatures above 450 degrees centigrade is less than 60 seconds.
(ii) Extreme Strength of Liquidmetal®-Liquidmetal® matrix is 5 to 10 times more wear resistant than silver brazing alloys. As a result, LM will consistently outperform any other diamond bonding matrix available. Thus, the 5× to 10× strength of Liquidmetal® when compared to traditional brazing alloys will increase the final edge durability to over 100 years of typical kitchen use, equivalent to a permanent edge life.
(iii) Higher Performance of Diamond Particles-Most brazing processes degrade the quality of the diamond particles. Often higher quality, thus more costly, diamond particles are used in anticipation of the diamonds degrading during the brazing procedure. However, the low temperature forming process of Liquidmetal® allows us to utilize less costly diamond particles.

FIG. 3 shows a step in the making of a diamond cutting tool with amorphous alloy as a matrix according to an embodiment. FIG. 3, (A) and (B) show a base material 301, a Liquidmetal® strip 302 and diamond particles 303 arranged in a predefined pattern. FIG. 3, (A) shows that the base material 301 is heated 304 until desired areas of Liquidmetal® reach 450 degrees centigrade to 500 degrees centigrade. FIG. 3, (A) shows that a pressure 305 is applied until the Liquidmetal® fills the groove and bonds the three materials, base 301, diamonds 303, and Liquidmetal® 302. In an embodiment, the pressure is applied on all the sides such that the diamond particles are embedded, and the rest of the amorphous material conforms to the shape of the shape of the sharp edge of the blade. A blade may be designed to minimize any grinding of material surrounding diamond particles as shown in dotted portion of the (B) of FIG. 3. In an embodiment, the first portion may be the upper half portion where the groove is formed, and the lower half portion is the second portion. In an embodiment, the first portion is the portion where the amorphous alloy will be placed, and the rest of the base portion is the second portion.

In an embodiment, the diamond particles are arranged on a plain flat surface on which the amorphous alloy strip is placed. Further on top of the amorphous alloy the base block is placed, and the heat and pressure are applied.

Once the melting process essentially allows the Liquidmetal® to occupy space and compress the diamond particles within, the post-operative procedure involves grinding the opposite side of the sharp edge. As shown in FIG. 3(B), the initial form starts with a larger, more substantial base. Subsequently, the opposite side of the sharp edge (dotted area) is removed by any metal cutting process or grinding. The reason for this approach is that once the diamonds are in place, the sharp edge, which is the cutting edge, is not grinded. Instead, a small strip, a Liquidmetal® strip, is placed on selected diamonds that lay flat, shape is selected such that they lay flat due to their shape. These diamonds are not spherical; they have a flattened profile, ensuring a relatively consistent height-to-width ratio. This characteristic allows them to lay flat. Then, either glue, or semi-bond, them to the strip, securing them in the correct position to prevent movement. When the Liquidmetal® is heated, and pressure is applied, the diamonds are pressed down within that plane, and the Liquidmetal® material surrounds and encapsulates them.

Benefits of Liquidmetal® diamond cutting edge: According to an embodiment, there is no need to sharpen the edge from initial production.

According to an embodiment, it is a device comprising, a base material; an amorphous alloy forming an amorphous alloy matrix layer; and a plurality of diamond particles embedded in the amorphous alloy matrix layer forming a cutting edge, wherein the amorphous alloy matrix layer bonds the plurality of diamond particles to the base material; and wherein the amorphous alloy matrix layer (Liquidmetal® strip) is at least 300 microns in thickness prior to being applied to the diamond particles; and wherein the device is operable as a cutting tool. According to an embodiment of the device, the cutting tool is a knife.

According to an embodiment of the device, the plurality of diamond particles is pre-sharpened. According to an embodiment of the device, the plurality of diamond particles is of a size ranging from 0.002 mm to 0.02 mm. According to an embodiment of the device, the plurality of diamond particles is operable to form a serrated edge on the cutting edge. According to an embodiment of the device, a handle for the device is comprising at least one of a steel, aluminum, and plastic.

In an embodiment, the device is made by placing diamonds on the surface of the amorphous material layer. The process involves using a magnifier or microscope to meticulously position these diamond particles along the edge. This approach ensures that 100% of the cutting action is carried out by the diamonds. The mixture of Liquidmetal® and other materials functions as a binder, with the diamonds protruding, creating a serrated edge. Unlike conventional methods where diamond particles are sprayed onto the material when it is hot, the current process involves precision placement before any heating occurs.

To illustrate, a bonding material, approximately one millimeter thick and two to three millimeters wide, is shaped to match the edge of the knife. Applying a specialized adhesive, diamonds are strategically positioned with careful consideration of their selection, shape, and dimensions. In an embodiment, the diamond particles are arranged in a manner that forms a jagged edge. Once pressed down, the diamond particles firmly stay in place. Unlike prior art approaches that involve spraying diamond particles onto hot material, the current method involves precise pre-made arrangement of diamond particles. Another distinctive feature is the strength of the Liquidmetal® in our diamond matrix, surpassing other matrices used in diamond composites. This strength prevents the use of alternative methods for sharpening the metal-diamond matrix. Consequently, the process results in an edge that does not require sharpening in the traditional sense. Rather than attempting to remove material from the diamonds for sharpness, the process begins with pre-jagged shapes, sizes, and particle arrangements. The diamonds are laid out according to the desired configuration, and due to the nature of the epoxy used, which burns at temperatures of 300 to 400 degrees, they remain in position when pressed down. This approach results in a unique diamond tipped cutting tool having a sharp edge.

In an embodiment, the size of the diamond particle separation length is varied based on the application—there is no one-size-fits-all approach. The efficiency and functionality of the cutting edge can be tailored by pre-selecting the diamond size. To achieve this, diamond particles are meticulously positioned using a combination of a microscope and magnifying system. In an embodiment, the magnification can be 20× to 30× during production for laying the diamond particles in a predefined pattern.

Furthermore, the cutting tool comprising diamond particles may be applicable to various cutting applications, including grinding wheels with diamond particles. The potential applications are not limited; the product made using the process mentioned herein can be adapted for a wide range of uses.

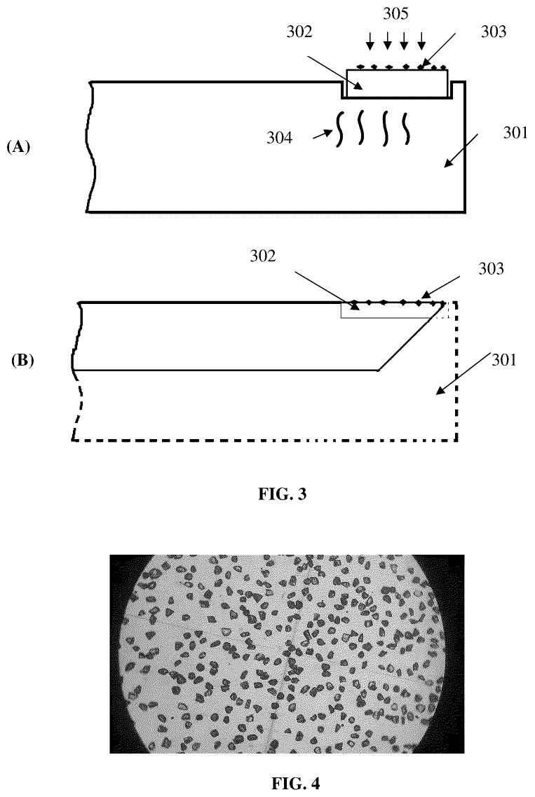

FIG. 4 shows pre-sharpened diamond particles arranged on an amorphous alloy according to an embodiment. Pre-sharpened diamond particles comprise tips having radius of less than 0.002 mm, the tallest dimension may be approximately 0.02 mm. The side width is about 0.005 mm. This can be compared to ultra-small brokens pieces of glass forming super focused tips on the cutting edge.

In an embodiment, the diamond particles are arranged in a predefined pattern, for example, flat on one of the diamond particle sides. The process of laying the diamond particles flat on their sides and pressing/applying pressure from above will help to keep the sharpest edge oriented in a vertical position to the cutting edge of the blades. The combination of pre-sharpened particles and keeping them aligned properly according to a predefined pattern where the cutting edge of the diamonds forms the blade's cutting edge, eliminates the cost of having to sharpen diamonds. The cutting edge may be formed either with sharp pointed corners and edges forming serrations or sharp edges arranged continuously to form the flat sharp edge without serrations.

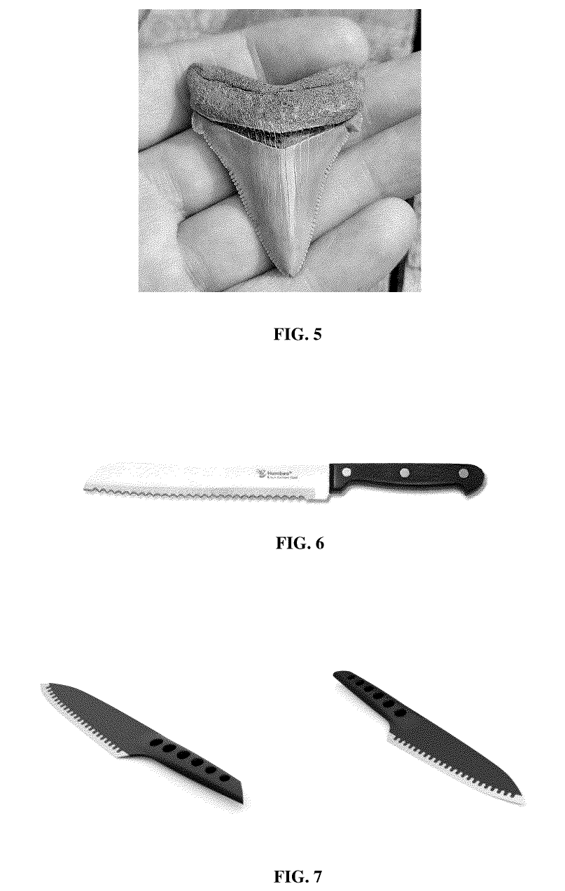

FIG. 5 shows a serrated edge of a shark's tooth according to an embodiment. Serrated edge helps this shark's teeth to tear through flesh with less effort and this bread knife to slice through soft bread without crushing soft bread. The cutting tip is at a greater attack angle than flat edges, which are near parallel. FIG. 6 and FIG. 7 shows a serrated edge of a prior art knife according to an embodiment. A micro serrated edge is sharp, efficient, and safe. Serrations give the blade's cutting edge less contact area than a smooth blade, which increases the applied pressure at each point of contact, and the points of contact are at a sharper angle to the material being cut. Key disadvantage of steel serrated edges is the difficulty of resharpening. However, a Diamond Micro Serrated edge retains the advantages of being more efficient without the need to be resharpened.

The formation of serrated edges on a knife through mechanical means of adjusting the width. The width of the serration can be adjusted by modifying the size of the diamond particles. Some of these particles may be too small to be visible to the naked eye, while others may be of a larger size.

When the diamond size is almost like dust, the serrated edge may not be easily noticeable to the naked eye at that particle size. It is more akin to the texture of sandpaper rather than a distinct separation. The serration is present, but at the microscopic level due to the size of the diamonds involved. In an embodiment, when the diamond particle size is bigger, the serrations are clearly visible to the human eye.

Other benefits: Since the main cutting edge is comprised of diamond powder and Liquidmetal® matrix, the rest of the blade and handle can be made of a wide range of materials, including Steel, Aluminum, Plastic, or various combinations of materials. The area represented in the black in FIG. 7 could be selected from a range of materials and designs.

Cost benefits: Other than the Diamond/Liquidmetal® edge, the rest of the knife can be injection molded from Aluminum or plastics. Injection molding is highly cost efficient and also can generate 3 dimensional shapes vs. traditional flat blades with a handle. Most commercial knives are sharpened weekly; a knife can cost over $500. Even if a knife is sharpened once a year with a 5 year useful life, it can cost over $25 per year. With the 100 year life expectancy, Liquidmetal® knives' expected cost to a consumer is less than $1 per year.

Liquidmetal® comprises amorphous alloys. Amorphous Alloys may refer to a solid solution of two or more metal elements (e.g., at least 2, 3, 4, 5, or more elements) or an intermetallic compound (including at least one metal element and at least one non-metal element). The term “element” herein may refer to an element that may be found in the Periodic Table. A metal may refer to any alkali metals, alkaline earth metals, transition metals, post-transition metals, lanthanides, actinides, and metalloids.

An amorphous alloy may refer to an alloy having an amorphous, non-crystalline atomic or microstructure. The amorphous structure may refer to a glassy structure with no observable long range order; in some instances, an amorphous structure may exhibit some short range order. Thus, an amorphous alloy may sometimes be referred to as a “metallic glass.” An amorphous alloy may refer to an alloy that is at least partially amorphous, including at least substantially amorphous, such as entirely amorphous, depending on the context. In one embodiment, an amorphous alloy may be an alloy of which at least about 50% is an amorphous phase—e.g., at least about 60%, about 70%, about 80%, about 90%, about 95%, about 99% or more. The percentage herein may refer to volume percent or weight percent, depending on the context. The term “phase” herein may refer to a physically distinctive form of a substance, such as microstructure. For example, a solid and a liquid are different phases. Similarly, an amorphous phase is different from a crystalline phase.

Amorphous alloys may contain a variety of metal elements and/or non-metal elements. In some embodiments, the amorphous alloys may comprise zirconium, titanium, iron, copper, nickel, gold, platinum, palladium, aluminum, or combinations thereof. In some embodiments, the amorphous alloys may be zirconium-based, titanium-based, iron-based, copper-based, nickel-based, gold-based, platinum-based, palladium-based, or aluminum-based. The term “M-based” when referred to an alloy may refer to an alloy comprising at least about 30% of the M element—e.g., about 40%, about 50%, about 60%, about 70%, about 80%, about 90%, about 95%, or more. The percentage herein may refer to volume percent or weight percent, depending on the context. An amorphous alloy may be a bulk solidifying amorphous alloy. A bulk solidifying amorphous alloy, or bulk amorphous alloy, or bulk metallic glass (“BMG”), may refer to an amorphous alloy that has at least one dimension in the millimeter range, which is substantially thicker than conventional amorphous alloys, which generally have a thickness of 0.02 mm. In one embodiment, this dimension may refer to the smallest dimension. Depending on the geometry, the dimension may refer to thickness, height, length, width, radius, and the like. In some embodiments, this smallest dimension may be at least about 0.5 mm—e.g., about 1 mm, about 2 mm, about 3 mm, about 4 mm, about 5 mm, about 6 mm, about 8 mm, about 10 mm, about 12 mm, or more. The magnitude of the largest dimension is not limited and may be in the millimeter range, centimeter range, or even meter range.

An amorphous alloy, including a bulk amorphous alloy, described herein may have a critical cooling rate of about 500 K/sec (1 degrees Kelvin/sec=1 degrees Celsius/sec) or less, in contrast to that of 105 K/sec or more for conventional amorphous alloys. The term “critical cooling rate” herein may refer to the cooling rate below which an amorphous structure is not energetically favorable and thus is not likely to form during a fabrication process. In some embodiments, the critical cooling rate of the amorphous alloy described herein may be, for example, about 400 K/sec or less—e.g., about 300 K/sec or less, about 250 K/sec or less, about 200 K/sec or less. Some examples of bulk solidifying amorphous alloys may be found in U.S. Pat. Nos. 5,288,344; 5,368,659; 5,618,359; and 5,735,975 which are incorporated herein in entirety. In some embodiments wherein the desired diameter (or width, thickness, etc., depending on the geometry) is small, a higher cooler rate, such as one used in the conventional amorphous alloy fabrication process, may be used.

The amorphous alloy may have a variety of chemical compositions. In one embodiment, the amorphous alloy is a Zr-based alloy, such as a Zr—Ti based alloy, such as (Zr, Ti)ₐ(Ni, Cu, Fe)_{b}(Be, Al, Si, B)_{c}, where each of a, b, c, is independently a number representing atomic % and (subscript) a is in the range of from 30 to 75, b is in the range of from 5 to 60, and c is in the range of from 0 to 50. Other incidental, inevitable minute amounts of impurities may also be present. In some embodiments, these alloys may accommodate substantial amounts of other transition metals, such as Nb, Cr, V, Co. A “substantial amount” in one embodiment may refer to about 5 atomic % or more—e.g., 10 atomic %, 20 atomic %, 30 atomic %, or more.

In one embodiment, an amorphous alloy herein may have the chemical formula (Zr, Ti)_{b}(Ni, Cu)_{b}(Be)_{c}, where each of a, b, c, is independently a number representing atomic % and subscript a is in the range of from 40 to 75, b is in the range of from 5 to 50, and c is in the range of from 5 to 50. Other incidental, inevitable minute amounts of impurities may also be present. In another embodiment, the alloy may have a composition (Zr, Ti)ₐ(Ni, Cu)_{b}(Be)_{c}, where each of a, b, c, is independently a number representing atomic % and a is in the range of from 45 to 65, b is in the range of from 7.5 to 35, and c is in the range of from 10 to 37.5 in atomic percentages.

In another embodiment, the amorphous alloy described herein may have the chemical formula (Zr)ₐ(Nb, Ti)_{b}(Ni, Cu)_{c}(Al)_{d}, where each of a, b, c, d is independently a number representing atomic % and a is in the range of from 45 to 65, b is in the range of from 0 to 10, c is in the range of from 20 to 40, and d is in the range of from 7.5 to 15. Other incidental, inevitable minute amounts of impurities may also be present.

In some embodiments, the amorphous alloy may be a ferrous metal based alloy, such as a (Fe, Ni, Co) based compositions. Examples of such compositions are disclosed in U.S. Pat. No. 6,325,868 and in publications (A. Inoue et. al., Appl. Phys. Lett., Volume 71, p 464 (1997)), (Shen et. al., Mater. Trans., JIM, Volume 42, p 2136 (2001)), and Japanese patent application 2000126277 (Pub. #JP2001303218A). For example, the alloy may be Fe₇₂A₁₅Ga₂P₁₁C₆B₄, or Fe₇₂A₁₇Zr₁₀Mo₅W₂B₁₅.

Amorphous alloys, including bulk solidifying amorphous alloys, may have high strength and high hardness. Strength may refer to tensile or compressive strength, depending on the context. For example, Zr and Ti-based amorphous alloys may have tensile yield strengths of about 250 ksi or higher, hardness values of about 450 Vickers or higher, or both. In some embodiments, the tensile yield strength may be about 300 ksi or higher—e.g., at least about 400 ksi, about 500 ksi, about 600 ksi, about 800 ksi, or higher. In some embodiments, the hardness value may be at least about 500 Vickers—e.g., at least about 550, about 600, about 700, about 800, about 900 Vickers, or higher.

In one embodiment, ferrous metal based amorphous alloys, including the ferrous metal based bulk solidifying amorphous alloys, can have tensile yield strengths of about 500 ksi or higher and hardness values of about 1000 Vickers or higher. In some embodiments, the tensile yield strength may be about 550 ksi or higher—e.g., at least about 600 ksi, about 700 ksi, about 800 ksi, about 900 ksi, or higher. In some embodiments, the hardness value may be at least about 1000 Vickers—e.g., at least about 1100 Vickers, about 1200 Vickers, about 1400 Vickers, about 1500 Vickers, about 1600 Vickers, or higher.

As such, any of the afore-described amorphous alloys may have a desirable strength-to-weight ratio. Furthermore, amorphous alloys, particularly the Zr- or Ti-based alloys, may exhibit good corrosion resistance and environmental durability. The corrosion herein may refer to chemical corrosion, stress corrosion, or a combination thereof.

The amorphous alloys, including bulk amorphous alloys, described herein may have a high elastic strain limit of at least about 0.5%, including at least about 1%, about 1.2%, about 1.5%, about 1.6%, about 1.8%, about 2%, or more—this value for high elastic strain limit of amorphous alloys described herein is much higher than any other metal alloy known to date.

In some embodiments, the amorphous alloys, including bulk amorphous alloys, may additionally include some crystalline materials, such as crystalline alloys. The crystalline material may have the same or different chemistry from the amorphous alloy. For example, in the case wherein the crystalline alloy and the amorphous alloy have the same chemical composition, they may differ from each other only with respect to the microstructure.

In some embodiments, crystalline precipitates in amorphous alloys may have an undesirable effect on the properties of amorphous alloys, especially on the toughness and strength of these alloys, and as such it is generally preferred to minimize the volume fraction of these precipitates. However, there may be cases in which ductile crystalline phases precipitate in-situ during the processing of amorphous alloys, which may be beneficial to the properties of amorphous alloys, especially to the toughness and ductility of the alloys. One exemplary case is disclosed in C. C. Hays et. al, Physical Review Letters, Vol. 84, p 2901, 2000. In at least one embodiment herein, the crystalline precipitates may comprise a metal or an alloy, wherein the alloy may have a composition that is the same as the composition of the amorphous alloy or a composition that is different from the composition of the amorphous alloy. Such amorphous alloys comprising these beneficial crystalline precipitates may be employed in at least one embodiment described herein.

A particular advantage of bulk solidifying amorphous alloys is their stability in the supercooled liquid region, defined as the viscous liquid regime above the glass transition temperature in one embodiment. The stability of this viscous liquid regime may be generally measured with ΔT, which in one embodiment herein refers to the difference between the onset of crystallization temperature, Tx, and the onset of glass transition temperature, Tg, as determined from standard Differential Scanning calorimetry (“DSC”) measurements at conventional heating rates (e.g., 20° C./min). In some embodiments, the bulk solidifying amorphous alloys may have ΔT of at least about 30° C. . . . e.g., at least about 50° C., about 60° C., about 70° C., about 80° C., about 90° C., or more.

According to an embodiment, the amorphous material comprises an amorphous alloy that has an elastic limit of at least 1.5% strain selected from (Zr,Ti)ₐ(Ni,Cu,Fe)_{b}(Be,Al,Si,B)_{c} wherein a=30-75; b=5-60 & c=0-50 atomic percentages; (Zr,Ti)ₐ(Ni,Cu)_{b}(Be)_{c} wherein a=40-75; b=5-50; & c=5-50 in atomic percentages; (Zr,Ti)ₐ(Ni,Cu)_{b}(Be)_{c} wherein a=40-65; b=7.5-35; & c=10-37.5 in atomic percentages; and (zr)ₐ(Nb,Ti)_{b}(Ni,Cu)_{c}(Al)_{d} wherein a=45-65; b=0-10; c=20-40; & d=7.5-15.

According to an embodiment, the amorphous alloy comprises a Zr-based, a Ti-based, a Zr—Ti-based, an Fe-based, or combinations thereof, amorphous alloy.

According to an embodiment, the amorphous alloy is at least substantially free of Be. According to an embodiment, the amorphous alloy further comprises a plurality of crystalline precipitates.

According to an embodiment, the matrix may comprise a plurality of layers comprising a plurality of structural components comprising wires, strips, fibers, ribbons, or combinations thereof. According to an embodiment, the plurality of the structural components comprises a series of horizontally aligned strips. According to an embodiment, the plurality of the structural components comprises a mesh of horizontally and longitudinally aligned fibers. According to an embodiment, at least one of the plurality of the structural components comprises (i) fibers having a diameter of between about 0.01 mm and about 0.5 mm, or (ii) ribbons having a thickness of between about 0.023 mm and 0.030 mm and a width between about 2 mm and about 213 mm.

Amorphous ribbons: Amorphous ribbons, also known as metallic glass ribbons or metallic glass foils, are unique materials with a non-crystalline, amorphous atomic structure. Amorphous ribbons are typically thin and flat, with widths ranging from a fraction of a millimeter (e.g., around 0.025 mm or 25 micrometers) to several millimeters. Their thickness can vary but is often in the range of tens to hundreds of micrometers. The length of amorphous ribbons can be quite long, often wound onto spools or rolls and can be cut to any desired length. Amorphous ribbons are typically made from alloys of various metallic elements. Common elements used in the composition of metallic glasses include transition metal elements like iron (Fe), nickel (Ni), and cobalt (Co), and are often used as primary constituents, Metalloid elements like boron (B) and silicon (Si) are added to the alloy to disrupt the formation of a crystalline structure, promoting the amorphous state, and small amounts of other elements, such as phosphorus (P), carbon (C), or chromium (Cr) may be included to fine-tune the properties of the alloy.

The specific composition of amorphous ribbons can vary depending on the desired properties and intended applications. Amorphous ribbons are produced through a rapid solidification process called melt spinning, where molten metal is rapidly quenched onto a rotating cooled wheel, preventing the formation of a crystalline structure. This rapid cooling results in the amorphous atomic arrangement characteristic of metallic glasses. The thin and flat shape of the ribbons makes them conducive to applications where a combination of unique properties, such as high strength, magnetic characteristics, or corrosion resistance, is needed.

In an embodiment, amorphous material comprises iron based amorphous ribbons.

In an embodiment, iron based amorphous ribbons comprise iron in a first range of 84-100%, silicon in a second range of 0-10%, boron in a third range of 0-5%, and manganese in a fourth range of 0-2%.

In an embodiment, the iron based amorphous ribbons comprise iron in a first range of 0-100%, cobalt in a second range of 0-85%, Nickel in a third range of 0-50%, silicon in a fourth range of 0-10%, molybdenum in a fifth range of 0-8%, boron in a sixth range of 0-5%, and manganese in a seventh range of 0-2%.

In an embodiment, the amorphous material comprises an amorphous alloy that has an elastic strain limit of at least 1.5% selected from (Zr,Ti)ₐ(Ni,Cu,Fe)_{b}(Be,Al,Si,B)_{c} wherein a=30-75; b=5-60 & c=0-50 atomic percentages; (Zr,Ti)ₐ(Ni,Cu)_{b}(Be)_{c} wherein a=40-75; b=5-50; & c=5-50 in atomic percentages; (Zr,Ti)ₐ(Ni,Cu)_{b}(Be)_{c} wherein a=40-65; b=7.5-35; & c=10-37.5 in atomic percentages; and (Zr)ₐ(Nb,Ti)_{b}(Ni,Cu)_{c}(Al)_{d} and wherein a=45-65; b=0-10; c=20-40; & d=7.5-15 in atomic percentages.

In an embodiment, the amorphous material comprises silica based glass sheets.

In an embodiment, the amorphous alloy comprises a Zr-based, a Ti-based, a Zr—Ti-based, an Fe-based, or combinations thereof, amorphous alloy.

In an embodiment, the amorphous alloy is at least substantially free of Be.

In an embodiment, the amorphous alloy further comprises a plurality of crystalline precipitates.

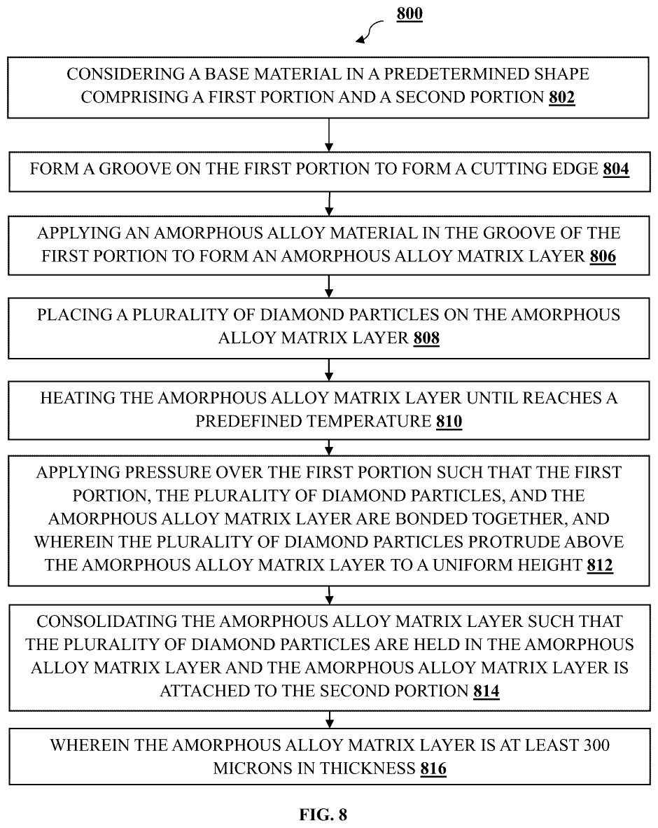

FIG. 8 shows a flowchart of a process for making a diamond tipped cutting tool according to an embodiment. According to an embodiment, it is a method 800, comprising considering a base material in a predetermined shape comprising a first portion and a second portion as shown at 802; forming a groove on the first portion to form a cutting edge as shown at 804; applying an amorphous alloy material in the groove of the first portion to form an amorphous alloy matrix layer as shown at 806; placing a plurality of diamond particles on the amorphous alloy matrix layer as shown at 808; heating the amorphous alloy matrix layer until reaches a predefined temperature as shown at 810; applying pressure over the first portion such that the first portion, the plurality of diamond particles, and the amorphous alloy matrix layer are bonded together, and wherein the plurality of diamond particles protrude above the amorphous alloy matrix layer to a uniform height as shown at 812; and consolidating the amorphous alloy matrix layer such that the plurality of diamond particles is held in the amorphous alloy matrix layer and the amorphous alloy matrix layer is attached to the second portion as shown at 814; and wherein the amorphous alloy matrix layer is at least 300 microns in thickness as shown at 816; and wherein the method is operable for making the cutting tool comprising the plurality of diamond particles forming the cutting edge.

According to an embodiment of the method, the predefined temperature is in a range of 400° C. to 500° C. According to an embodiment of the method, the amorphous alloy matrix layer is 5 to 10 times more wear resistant than a silver brazing alloy. According to an embodiment of the method, the base material, the plurality of diamond particles, and the amorphous alloy matrix layer experience an elevated temperature in a range of 400° C. to 500° C. for less than 60 seconds.

According to an embodiment of the method, the plurality of diamond particles is pre-sharpened. According to an embodiment of the method, the plurality of diamond particles is of a size ranging from 0.002 mm to 0.02 mm. According to an embodiment of the method, the plurality of diamond particles is laid flat on the first side and pressed from the second side so that a sharp edge is oriented in a vertical position to form the cutting edge.

According to an embodiment of the method, the base material comprises at least one of steel, aluminum, and an alloy. According to an embodiment of the method, the cutting tool is a knife. According to an embodiment of the method, the second portion is machined to form the shape of the knife.

According to an embodiment of the method, the knife further comprises a handle portion secured to the knife portion, wherein the handle portion is made from a non-slip material comprising textured polymer. According to an embodiment of the method, the plurality of diamond particles is arranged in a predetermined pattern on the amorphous alloy matrix layer. According to an embodiment of the method, the predetermined pattern comprises a position and orientation of an edge of each diamond particle of the plurality of diamond particles and a separation between any two diamond particles of the plurality of diamond particles. According to an embodiment of the method, a layer of adhesive is used to keep the plurality of diamond particles in place on the amorphous alloy matrix layer. According to an embodiment of the method, the plurality of diamond particles protrude above the amorphous alloy matrix layer to form a serrated cutting edge.

According to an embodiment of the method, the handle is foldable allowing a blade portion of the cutting tool to be securely enclosed within the handle.

According to an embodiment of the method, a fusing of the amorphous alloy matrix layer to the second portion comprises heating the amorphous alloy matrix layer to a predefined temperature in a range of 400° C. to 500° C.

According to an embodiment of the method, the amorphous alloy material comprises silica or silica based glass sheets. According to an embodiment of the method, the amorphous alloy material comprises iron based amorphous ribbons. According to an embodiment of the method, the iron based amorphous ribbons comprise iron in a first range of 84-100%, silicon in a second range of 0-10%, boron in a third range of 0-5%, and manganese in a fourth range of 0-2%. According to an embodiment of the method, the iron based amorphous ribbons comprise iron in a first range of 0-100%, cobalt in a second a second range of 0-85%, Nickel in a third range of 0-50%, silicon in a fourth range of 0-10%, molybdenum in a fifth range of 0-8%, boron in a sixth range of 0-5%, and manganese in a seventh range of 0-2%.

According to an embodiment of the method, the amorphous alloy material comprises an amorphous alloy that has an elastic strain limit of at least 1.5% selected from (Zr,Ti)ₐ(Ni,Cu,Fe)_{b}(Be,Al,Si,B)_{c} wherein a=30-75; b=5-60 & c=0-50 atomic percentages; (Zr,Ti)ₐ(Ni,Cu)_{b}(Be)_{c} wherein a=40-75; b=5-50; & c=5-50 in atomic percentages; (Zr,Ti)ₐ(Ni,Cu)_{b}(Be)_{c} wherein a=40-65; b=7.5-35; & c=10-37.5 in atomic percentages; and (Zr)ₐ(Nb,Ti)_{b}(Ni,Cu)_{c}(Al)_{d} and wherein a=45-65; b=0-10; c=20-40; & d=7.5-15 in atomic percentages. According to an embodiment of the method, the amorphous alloy material comprises a Zr-based, a Ti-based, a Zr—Ti-based, an Fe-based, or combinations thereof, amorphous alloy. According to an embodiment of the method, the amorphous alloy material is at least substantially free of Be. According to an embodiment of the method, the amorphous alloy material further comprises a plurality of crystalline precipitates. According to an embodiment of the method, the amorphous alloy matrix layer comprises a composite material having 50% by volume of amorphous material. According to an embodiment of the method, the plurality of diamond particles are lightly bonded to the amorphous alloy and held in place with an evaporative glue. According to an embodiment, it is a method comprising, casting a blade portion of a cutting tool using a metal or a ceramic; and fusing an amorphous alloy material to an edge of the blade portion using a hot forming process; and wherein a cutting edge area comprises at least 50% by volume of the amorphous alloy material and a thickness of the amorphous alloy material on the edge is at least 300 microns. According to an embodiment of the method, the hot forming process is a hot pressing process. According to an embodiment of the method, the cutting edge area comprises diamond particles.

The Liquidmetal® exhibits remarkable malleability within the temperature range of 400 to 500 degrees Celsius. At this temperature, it avoids charging the surface, preventing the formation of an undesirable oxide layer. At this state, diamond particles are introduced into the Liquidmetal®, specifically the amorphous metal on one side, while simultaneously compressing it into a knife base. Once this process is completed, the end can be used for cutting, leveraging the inherent hardness and sharpness of diamonds, which are selected based on size and shape to ensure the presence of proper cutting tips. The process helps in avoiding the need for subsequent sharpening, as attempting to sharpen the diamonds/cutting edge would significantly elevate the cost structure. The inherent hardness of diamonds eliminates the necessity for frequent resharpening. Various sizes and shapes of particles of diamonds may be used.

In an embodiment, small, jagged diamond particles of uniform size are used. In an embodiment, particles of range of 100-600 mesh size may be used. Optimal size of the diamond particles may vary depending on the application and desired characteristics. Some knives may benefit with a rougher, larger diamond size, while others may require a smaller size. Optimal size and shape of diamond particles depend on application of the cutting tool.

Though prior art mentioned amorphous materials for a knife, where the material is a coating material rather than a bulk material, prior art employs a block of non-amorphous material with an added layer of amorphous material and requires resharpening. Coating material and bulk material differ in their application and structural characteristics. Coating material is a thin layer applied to the surface of a substrate, serving various purposes such as protection, aesthetics, or specific functionalities. Coating material typically involves a selective application to achieve desired properties without altering the entire structure. In contrast, bulk material refers to the substance that constitutes the main body or mass of an object, possessing uniform properties throughout its volume. Unlike coating material, bulk material forms the core composition of an object, contributing to its overall structural integrity and functionality. While coating material focuses on surface modification, bulk material defines the fundamental properties of the object itself.

Although sharp-edged cutting tools are produced from a variety of materials, each has significant disadvantages. For example, sharp-edged cutting tools are produced from hard materials such as carbides, sapphire and diamonds which provide sharp and effective cutting edges; however, these materials have a substantially higher manufacturing cost. In addition, cutting edges of blades made from these materials are extremely fragile due to the materials intrinsically low toughness. Sharp-edged cutting tools made of conventional metals, such as steel (e.g., carbon steel), can be produced at relatively low cost and can be used as disposable items. However, the cutting performance of these blades does not match that of the more expensive high hardness materials. Steel is soft and knives made of steel tend to rust and get dull within a few months of use. On the other spectrum, ceramic is about 5 times harder than steel, but has only a fraction of steel's ductility. Thus, most ceramic knives tend to lose their edge through chipping or breakage. Ceramic is too brittle to produce sharp durable knives. In some instances, a single misuse can damage or break a ceramic knife. Accordingly, steel and ceramic are not ideal blade materials. Steel's hardness is 4 to 6 GPa, which is a fraction of silicon carbide's or nitride's hardness. Although ceramic is 5× harder than steel, ceramic has about 1/10 the ductility of steel. Other materials, such as a bulk nitride or diamond composite material are quite difficult to machine and sharpen. Thus, most material scientists have accepted the mutually exclusive properties of hardness and ductility. More recently it has been suggested to produce cutting tools made from amorphous alloys. Although amorphous alloys have the potential to provide blades having high hardness, ductility, elastic limit, and corrosion resistance at a relatively low cost, thus far the size and type of blade that can be produced with these materials has been limited by the processes required to produce alloys having amorphous properties. For example, cutting blades made with amorphous alloys are described in U.S. Pat. No. Re 29,989 and U.S. Pat. No. 6,887,586, both of which are hereby incorporated by reference in their entirety. However, the device described in such prior art is limited with regards to manufacturing and realizing the amorphous properties of these alloys. Also, such prior art devices are made entirely with amorphous alloys or coated in their entirety, thus further resulting in higher costs to manufacture. Accordingly, there is a need for an improved cutting blade having good mechanical properties (including hardness and ductility), a sharp edge, and corrosion resistance that is of lower cost and that takes advantage of amorphous alloy properties.

The cutting tool could further comprise a handle mounted onto the body portion. In an embodiment, the fusing of the amorphous alloy material to the edge of the blade portion comprises one of the group of the following processes: welding, thermal spraying, laser cladding, electron beam welding, and baking. Yet another aspect provides a cutting tool with a blade portion having a sharpened edge and a body portion. The body portion is formed from a metal or a ceramic, and the sharpened edge includes an amorphous alloy material in which diamond particles are bonded or embedded. The diamond particles form the sharp edge, and the amorphous alloy area has at least 50% amorphous alloy material, and the amorphous alloy material is limited to the sharpened edge area. In an embodiment, the amorphous alloy material comprises approximately 20% to approximately 50% by weight of chromium. In an embodiment, the amorphous alloy material comprises approximately 30% to approximately 50% by weight of iron. In an embodiment, the amorphous alloy material comprises approximately 30% to approximately 60% by weight of zirconium. In an embodiment, the amorphous alloy material comprises the following mixture: from approximately 25 to 27% by weight of chromium, from approximately 2 to 2.2% by weight of boron, from approximately 16 to 18% by weight of molybdenum, from approximately 2 to 2.5% by weight of carbon and the remaining percentage by weight being iron, such that the total weight of the components are selected to total 100%. In an embodiment, the amorphous alloy material comprises the following mixture: from approximately 3.5 to 11% by weight of titanium, from approximately 13 to 15% by weight of copper, from approximately 10 to 12% by weight of nickel, approximately 2 to 4% by weight of X, and the remaining percentage by weight being zirconium, such that the total weight of the components are selected to total 100%, wherein X comprises: beryllium, aluminum, or a mixture thereof. In an embodiment, X comprises a mixture of beryllium and aluminum and wherein the ratio of aluminum to beryllium is 2.5:1.

In an embodiment, the amorphous alloy material comprises the following mixture: from approximately 43 to 46% by weight of chromium, from approximately 1.5 to 2.5% by weight of silicon, from approximately 5.5 to 6.5% by weight of boron, and the remaining percentage by weight being iron, such that the total weight of the components are selected to total 100%.

In an embodiment, the amorphous alloy material comprises an ex-situ additive selected from the group of diamond, sapphire, carbides, and borides.

In an embodiment, the amorphous alloy material comprises a composite material having 50% by volume of amorphous material.

In an embodiment, the thickness of the amorphous alloy material is up to approximately 300 microns. In an embodiment, the thickness of the amorphous alloy material is between at least approximately 200 microns and approximately 500 microns.

Bulk-solidifying amorphous alloys, or bulk metallic glasses (“BMG”), may be solidified and cooled at relatively slow rates, and they retain the amorphous, non-crystalline (i.e., glassy) state at room temperature. Amorphous alloys have many superior properties than their crystalline counterparts. However, if the cooling rate is not sufficiently high, crystals may form inside the alloy during cooling, so that the benefits of the amorphous state can be lost. For example, one challenge with the fabrication of bulk amorphous alloy parts is partial crystallization of the parts due to either slow cooling or impurities in the raw alloy material.

An amorphous or non-crystalline solid is a solid that lacks lattice periodicity, which is characteristic of a crystal. As used herein, an “amorphous solid” includes “glass” which is an amorphous solid that softens and transforms into a liquid-like state upon heating through the glass transition. Generally, amorphous materials lack the long-range order characteristic (lattice periodicity) of a crystal, though they can possess some short-range order at the atomic length scale due to the nature of chemical bonding. The distinction between amorphous solids and crystalline solids can be made based on lattice periodicity as determined by structural characterization techniques such as x-ray diffraction and transmission electron microscopy.

The alloy described herein can be crystalline, partially crystalline, amorphous, or substantially amorphous. For example, the alloy sample/specimen can include at least some crystallinity, with grains/crystals having sizes in the nanometer and/or micrometer ranges. Alternatively, the alloy can be substantially amorphous, such as fully amorphous. In one embodiment, the alloy composition is at least substantially not amorphous, such as being substantially crystalline, such as being entirely crystalline.

In one embodiment, the presence of a crystal or a plurality of crystals in an otherwise amorphous alloy can be construed as a “crystalline phase” therein. The degree of crystallinity (or “crystallinity” for short in some embodiments) of an alloy can refer to the amount of the crystalline phase present in the alloy. The degree can refer to, for example, a fraction of crystals present in the alloy. The fraction can refer to volume fraction or weight fraction, depending on the context. A measure of how ‘amorphous’ an amorphous alloy is can be amorphicity. Amorphicity can be measured in terms of a degree of crystallinity. For example, in one embodiment, an alloy having a low degree of crystallinity can be said to have a high degree of amorphicity. In one embodiment, for example, an alloy having 60 vol % crystalline phase can have a 40 vol % amorphous phase.

Amorphous Alloy or Amorphous Metal: An “amorphous alloy” is an alloy having an amorphous content of more than 50% by volume. In an embodiment more than 90% by volume of amorphous content. In an embodiment more than 95% by volume of amorphous content. In an embodiment more than 99% to almost 100% by volume of amorphous content. Note that, as described above, an alloy high in amorphicity is equivalently low in degree of crystallinity. An “amorphous metal” is an amorphous metal material with a disordered atomic-scale structure. In contrast to most metals, which are crystalline and therefore have a highly ordered arrangement of atoms, amorphous alloys are non-crystalline. Materials in which such a disordered structure is produced directly from the liquid state during cooling are sometimes referred to as “glasses.” Accordingly, amorphous metals are commonly referred to as “metallic glasses” or “glassy metals.” In one embodiment, a bulk metallic glass (“BMG”) can refer to an alloy, of which the microstructure is at least partially amorphous. However, there are several ways besides extremely rapid cooling to produce amorphous metals, including physical vapor deposition, solid-state reaction, ion irradiation, melt spinning, and mechanical alloying. Amorphous alloys can be a single class of materials, regardless of how they are prepared.

Amorphous metals can be produced through a variety of quick-cooling methods. For instance, amorphous metals can be produced by sputtering molten metal onto a spinning metal disk. The rapid cooling, on the order of millions of degrees a second, can be too fast for crystals to form, and the material is thus “locked in” a glassy state. Also, amorphous metals/alloys can be produced with critical cooling rates low enough to allow formation of amorphous structures in thick layers—e.g., bulk metallic glasses.

The terms “bulk metallic glass” (“BMG”), bulk amorphous alloy (“BAA”), and bulk solidifying amorphous alloy are used interchangeably herein. They refer to amorphous alloys having the smallest dimension at least in the millimeter range. For example, the dimension can be at least about 0.5 mm, such as at least about 1 mm, such as at least about 2 mm, such as at least about 4 mm, such as at least about 5 mm, such as at least about 6 mm, such as at least about 8 mm, such as at least about 10 mm, such as at least about 12 mm. Depending on the geometry, the dimension can refer to the diameter, radius, thickness, width, length, etc. A BMG can also be a metallic glass having at least one dimension in the centimeter range, such as at least about 1.0 cm, such as at least about 2.0 cm, such as at least about 5.0 cm, such as at least about 10.0 cm. In some embodiments, a BMG can have at least one dimension at least in the meter range. A BMG can take any of the shapes or forms described above, as related to a metallic glass. Accordingly, a BMG described herein in some embodiments can be different from a thin film made by a conventional deposition technique in one important aspect—the former can be of a much larger dimension than the latter.

Amorphous metals can be an alloy rather than a pure metal. The alloys may contain atoms of significantly different sizes, leading to low free volume (and therefore having viscosity up to orders of magnitude higher than other metals and alloys) in a molten state. The viscosity prevents the atoms from moving enough to form an ordered lattice. The material structure may result in low shrinkage during cooling and resistance to plastic deformation. The absence of grain boundaries, the weak spots of crystalline materials in some cases, may, for example, lead to better resistance to wear and corrosion. In one embodiment, amorphous metals, while technically glasses, may also be tougher and less brittle than oxide glasses and ceramics.

Thermal conductivity of amorphous materials may be lower than that of their crystalline counterparts. To achieve formation of an amorphous structure even during slow cooling, the alloy may be made of three or more components, leading to complex crystal units with higher potential energy and lower probability of formation. The formation of amorphous alloys can depend on several factors: the composition of the components of the alloy; the atomic radius of the components (preferably with a significant difference of over 12% to achieve high packing density and low free volume); and the negative heat of mixing the combination of components, inhibiting crystal nucleation, and prolonging the time the molten metal stays in a supercooled state. However, as the formation of an amorphous alloy is based on many different variables, it can be difficult to make a prior determination of whether an alloy composition would form an amorphous alloy.

Amorphous alloys, for example, of boron, silicon, phosphorus, and other glass formers with magnetic metals (iron, cobalt, nickel) may be magnetic, with low coercivity and high electrical resistance. The high resistance leads to low losses by eddy currents when subjected to alternating magnetic fields, a property useful, for example, as transformer magnetic cores.

Amorphous alloys may have a variety of potentially useful properties. In particular, they tend to be stronger than crystalline alloys of similar chemical composition, and they can sustain larger reversible (“elastic”) deformations than crystalline alloys. Amorphous metals derive their strength directly from their non-crystalline structure, which can have none of the defects (such as dislocations) that limit the strength of crystalline alloys. For example, one modern amorphous metal, known as Vitreloy™, has a tensile strength that is almost twice that of high-grade titanium. In some embodiments, metallic glasses at room temperature are not ductile and tend to fail suddenly when loaded with tension, which limits the material applicability in reliability-critical applications, as the impending failure is not evident. Therefore, to overcome this challenge, metal matrix composite materials, having a metallic glass matrix containing dendritic particles or fibers of a ductile crystalline metal, can be used. Alternatively, a BMG low in element(s) that tends to cause embitterment (e.g., Ni) can be used. For example, a Ni-free BMG can be used to improve the ductility of the BMG.

Another useful property of bulk amorphous alloys is that they can be true glasses; in other words, they can soften and flow upon heating. This can allow for easy processing, such as by injection molding, in much the same way as polymers. As a result, amorphous alloys can be used for making sports equipment, medical devices, electronic components and equipment, cutting tools, and thin films. Thin films of amorphous metals can be deposited as protective coatings via a high velocity oxygen fuel technique.

A material can have an amorphous phase, a crystalline phase, or both. The amorphous and crystalline phases can have the same chemical composition and differ only in the microstructure-i.e., one amorphous and the other crystalline. Microstructure in one embodiment refers to the structure of a material as revealed by a microscope at 25× magnification or higher. Alternatively, the two phases can have different chemical compositions and microstructures. For example, a composition can be partially amorphous, substantially amorphous, or completely amorphous.

As described above, the degree of amorphicity (and conversely the degree of crystallinity) can be measured by the fraction of crystals present in the alloy. The degree can refer to volume fraction or weight fraction of the crystalline phase present in the alloy. A partially amorphous composition can refer to a composition of at least about 5 vol % of which is of an amorphous phase, such as at least about 10 vol %, such as at least about 20 vol %, such as at least about 40 vol %, such as at least about 60 vol %, such as at least about 80 vol %, such as at least about 90 vol %. The terms “substantially” and “about” have been defined elsewhere in this application. Accordingly, a composition that is at least substantially amorphous can refer to one of which at least about 90 vol % is amorphous, such as at least about 95 vol %, such as at least about 98 vol %, such as at least about 99 vol %, such as at least about 99.5 vol %, such as at least about 99.8 vol %, such as at least about 99.9 vol %. In one embodiment, a substantially amorphous composition can have some incidental, insignificant amount of crystalline phase present therein.

In one embodiment, an amorphous alloy composition can be homogeneous with respect to the amorphous phase. A substance that is uniform in composition is homogeneous. This is in contrast to a substance that is heterogeneous. The term “composition” refers to the chemical composition and/or microstructure in the substance. A substance is homogeneous when a volume of the substance is divided in half and both halves have substantially the same composition. For example, a particulate suspension is homogeneous when a volume of the particulate suspension is divided in half and both halves have substantially the same volume of particles. However, it might be possible to see the individual particles under a microscope. Another example of a homogeneous substance is air where different ingredients therein are equally suspended, though the particles, gasses and liquids in air can be analyzed separately or separated from air.

A composition that is homogeneous with respect to an amorphous alloy can refer to one having an amorphous phase substantially uniformly distributed throughout its microstructure. In other words, the composition macroscopically comprises a substantially uniformly distributed amorphous alloy throughout the composition. In an alternative embodiment, the composition can be of a composite, having an amorphous phase having therein a non-amorphous phase. The non-amorphous phase can be a crystal or a plurality of crystals. The crystals can be in the form of particulates of any shape, such as spherical, ellipsoid, wire-like, rod-like, sheet-like, flake-like, or an irregular shape. In one embodiment, it can have a dendritic form. For example, an at least partially amorphous composite composition can have a crystalline phase in the shape of dendrites dispersed in an amorphous phase matrix; the dispersion can be uniform or non-uniform, and the amorphous phase and the crystalline phase can have the same or a different chemical composition. In one embodiment, they have substantially the same chemical composition. In another embodiment, the crystalline phase can be more ductile than the BMG phase.

The method described herein can be applicable to any type of amorphous alloy. Similarly, in accordance with embodiments, the amorphous alloy described herein as a constituent of a composition or article can be of any type. The amorphous alloy can comprise the element Zr, Hf, Ti, Cu, Ni, Pt, Pd, Fe, Mg, Au, La, Ag, Al, Mo, Nb, Be, or combinations thereof. Namely, the alloy can include any combination of these elements in its chemical formula or chemical composition. The elements can be present at different weight or volume percentages. For example, an iron “based” alloy can refer to an alloy having a non-insignificant weight percentage of iron present therein, the weight percent can be, for example, at least about 20 wt (weight) %, such as at least about 40 wt %, such as at least about 50 wt %, such as at least about 60 wt %, such as at least about 80 wt %. Alternatively, in one embodiment, the above-described percentages can be volume percentages, instead of weight percentages. Accordingly, an amorphous alloy can be zirconium-based, titanium-based, platinum-based, palladium-based, gold-based, silver-based, copper-based, iron-based, nickel-based, aluminum-based, molybdenum-based, and the like. The alloy can also be free of any of the aforementioned elements to suit a particular purpose. For example, in some embodiments, the alloy, or the composition including the alloy, can be substantially free of nickel, aluminum, titanium, beryllium, or combinations thereof. In one embodiment, the alloy or the composite is completely free of nickel, aluminum, titanium, beryllium, or combinations thereof.

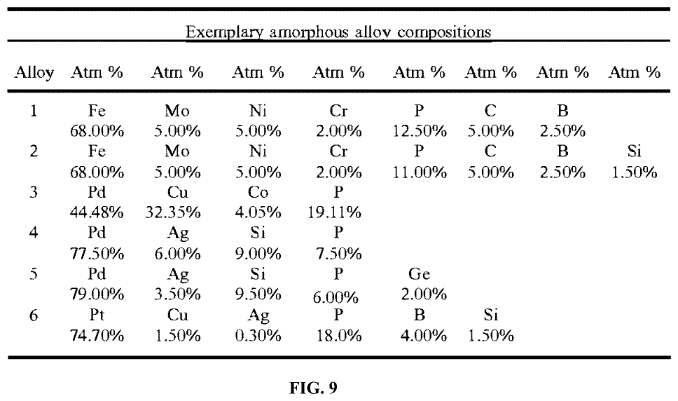

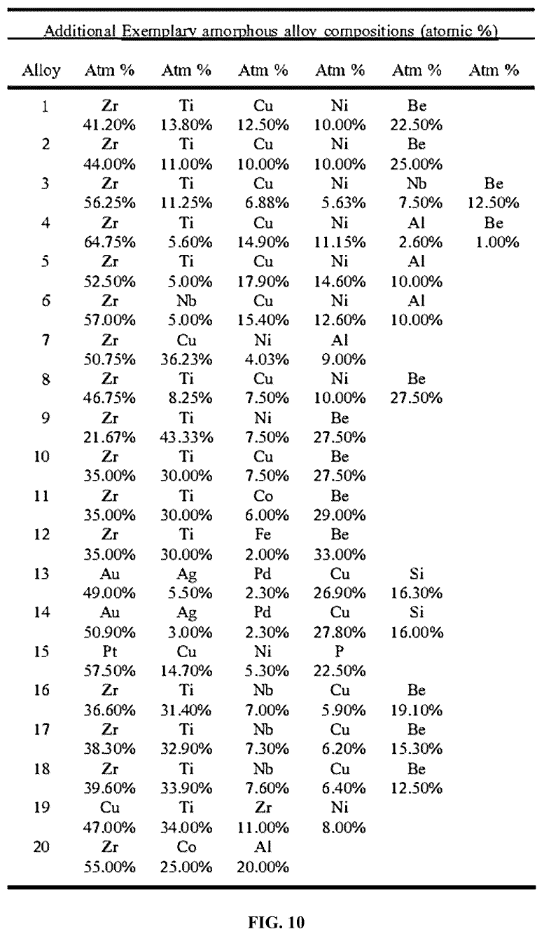

For example, the amorphous alloy can have the formula (Zr, Ti)ₐ(Ni, Cu, Fe)_{b}(Be, Al, Si, B)_{c}, wherein a, b, and c each represents a weight or atomic percentage. In one embodiment, a is in the range of from 30 to 75, b is in the range of from 5 to 60, and c is in the range of from 0 to 50 in atomic percentages. Alternatively, the amorphous alloy can have the formula (Zr, Ti)a(Ni, Cu)b(Be)c, wherein a, b, and c each represents a weight or atomic percentage. In one embodiment, a is in the range of from 40 to 75, b is in the range of from 5 to 50, and c is in the range of from 5 to 50 in atomic percentages. The alloy can also have the formula (Zr, Ti)ₐ(Ni, Cu)_{b}(Be)_{c}, wherein a, b, and c each represents a weight or atomic percentage. In one embodiment, a is in the range of from 45 to 65, b is in the range of from 7.5 to 35, and c is in the range of from 10 to 37.5 in atomic percentages. Alternatively, the alloy can have the formula (Zr)ₐ(Nb, Ti)_{b}(Ni, Cu)_{c}(Al)_{d}, wherein a, b, c, and d each represent a weight or atomic percentage. In one embodiment, a is in the range of from 45 to 65, b is in the range of from 0 to 10, c is in the range of from 20 to 40 and d is in the range of from 7.5 to 15 in atomic percentages. One exemplary embodiment of the afore described alloy system is a Zr—Ti—Ni—Cu—Be based amorphous alloy under the trade name Vitreloy®, such as Vitreloy-1 and Vitreloy-101, as fabricated by Liquidmetal Technologies (Liquidmetal®), CA, USA. Some examples of amorphous alloys of the different systems are provided in FIG. 9 and FIG. 10.

Other exemplary ferrous metal-based alloys include compositions such as those disclosed in U.S. Patent Application Publication Nos. 2007/0079907 and 2008/0118387 which are hereby incorporated in their entirety. These compositions include the Fe(Mn, Co, Ni, Cu) (C, Si, B, P, Al) system, wherein the Fe content is from 60 to 75 atomic percentage, the total of (Mn, Co, Ni, Cu) is in the range of from 5 to 25 atomic percentage, and the total of (C, Si, B, P, Al) is in the range of from 8 to 20 atomic percentage, as well as the exemplary composition Fe48Cr15Mo14Y2C15B6. They also include the alloy systems described by Fe—Cr—Mo—(Y,Ln)-C—B, Co—Cr—Mo-Ln-C—B, Fe—Mn—Cr—Mo—(Y,Ln)-C—B, (Fe, Cr, Co)—(Mo,Mn)—(C,B)—Y, Fe—(Co,Ni)—(Zr,Nb,Ta)—(Mo,W)—B, Fe—(Al,Ga)—(P,C,B,Si,Ge), Fe—(Co, Cr,Mo,Ga,Sb)—P—B—C, (Fe, Co)—B—Si—Nb alloys, and Fe—(Cr—Mo)—(C,B)—Tm, where Ln denotes a lanthanide element and Tm denotes a transition metal element. Furthermore, the amorphous alloy can also be one of the exemplary compositions Fe80P12.5C5B2.5, Fe80P11C5B2.5Si1.5, Fe74.5Mo5.5P12.5C5B2.5, Fe74.5Mo5.5P11C5B2.5Si1.5, Fe70Mo5Ni5P12.5C5B2.5, Fe70Mo5Ni5P11C5B2.5 Si1.5, Fe68Mo5Ni5Cr2P12.5C5B2.5, and Fe68Mo5Ni5Cr2P11C5B2.5Si1.5, described in U.S. Patent Application Publication No. 2010/0300148.

The amorphous alloys can also be ferrous alloys, such as (Fe, Ni, Co) based alloys. Examples of such compositions are disclosed in U.S. Pat. Nos. 6,325,868; 5,288,344; 5,368,659; 5,618,359; and U.S. Pat. No. 5,735,975, Inoue et al., Appl. Phys. Lett., Volume 71, p 464 (1997), Shen et al., Mater. Trans., JIM, Volume 42, p 2136 (2001), and Japanese Patent Application No. 200126277 (Pub. No. 2001303218 A). One exemplary composition is Fe72A15Ga2P11C6B4. Another example is Fe72A17Zr10Mo5W2B15. Another iron-based alloy system that can be used in the coating herein is disclosed in U.S. Patent Application Publication No. 2010/0084052, wherein the amorphous metal contains, for example, manganese (1 to 3 atomic %), yttrium (0.1 to 10 atomic %), and silicon (0.3 to 3.1 atomic %) in the range of composition given in parentheses; and that contains the following elements in the specified range of composition given in parentheses: chromium (15 to 20 atomic %), molybdenum (2 to 15 atomic %), tungsten (1 to 3 atomic %), boron (5 to 16 atomic %), carbon (3 to 16 atomic %), and the balance remaining is iron.

The afore described amorphous alloy systems can further include additional elements, such as additional transition metal elements, including Nb, Cr, V, and Co. The additional elements can be present at less than or equal to about 30 wt %, such as less than or equal to about 20 wt %, such as less than or equal to about 10 wt %, such as less than or equal to about 5 wt %. In one embodiment, the additional, optional element is at least one of cobalt, manganese, zirconium, tantalum, niobium, tungsten, yttrium, titanium, vanadium, and hafnium to form carbides and further improve wear and corrosion resistance. Further optional elements may include phosphorus, germanium, and arsenic, totaling up to about 2%, and preferably less than 1%, to reduce melting point. Otherwise, incidental impurities should be less than about 2% and preferably 0.5%.

In some embodiments, a composition having an amorphous alloy can include a small amount of impurities. The impurity elements can be intentionally added to modify the properties of the composition, such as improving the mechanical properties (e.g., hardness, strength, fracture mechanism, etc.) and/or improving the corrosion resistance. Alternatively, the impurities can be present as inevitable, incidental impurities, such as those obtained as a byproduct of processing and manufacturing. The impurities can be less than or equal to about 10 wt %, such as about 5 wt %, such as about 2 wt %, such as about 1 wt %, such as about 0.5 wt %, such as about 0.1 wt %. In some embodiments, these percentages can be volume percentages instead of weight percentages. In one embodiment, the alloy sample/composition consists essentially of the amorphous alloy (with only a small incidental amount of impurities). In another embodiment, the composition includes the amorphous alloy (with no observable trace of impurities).

In embodiments herein, the existence of a supercooled liquid region in which the bulk-solidifying amorphous alloy can exist as a high viscous liquid allows for superplastic forming. Large plastic deformations can be obtained. The ability to undergo large plastic deformation in the supercooled liquid region is used for the forming and/or cutting process. As opposed to solids, the liquid bulk solidifying alloy deforms locally which drastically lowers the required energy for cutting and forming. The ease of cutting and forming depends on the temperature of the alloy, the mold, and the cutting tool. As higher is the temperature, the lower is the viscosity, and consequently easier is the cutting and forming.

Embodiments herein can utilize a thermoplastic-forming process with amorphous alloys carried out between Tg and Tx, for example. Herein, Tx and Tg are determined from standard DSC measurements at typical heating rates (e.g., 20° C./min) at the onset of crystallization temperature and the onset of glass transition temperature.

In accordance with embodiments herein, the disclosed method 800 produces a final part wherein the additional coating layer fused onto the edge of the cutting tool has a higher thickness (i.e., is thicker on the edge) than a critical casting thickness of the casted alloy body.

Moreover, the time and temperature of the heating and shaping operation is selected such that the elastic strain limit of the amorphous alloy could be substantially preserved to be not less than 1.0%, and preferably not being less than 1.5%. In the context of the embodiments herein, temperatures around glass transition means the forming temperatures can be below glass transition, at or around glass transition, and above glass transition temperature, but preferably at temperatures below the crystallization temperature Tx. The cooling step is carried out at rates similar to the heating rates at the heating step, and preferably at rates greater than the heating rates at the heating step. In an embodiment, the cooling step is also achieved while forming and shaping loads are still maintained.

Application to a Cutting Tool: The following disclosure relates to methods for forming cutting tools that include fusing or applying amorphous alloy material towards a sharp edge area of a cutting tool whose body is casted or formed from a metal or a ceramic. The sharp edge area may include at least 50% bulk amorphous alloy. Also disclosed is a cutting tool with a blade portion having a sharpened edge and a body portion. The body portion is formed from a metal or a ceramic, and the sharpened edge includes an amorphous alloy material applied in the manner noted above. The sharpened edge area may include at least 50% bulk amorphous alloy. The thickness of the bulk amorphous alloy material on the edge may be between approximately 200-500 microns, for example.

In addition to the effects of hardness and ductility on durability of cutting tools or knives previously discussed, other factors contribute to the rapid loss of edge durability. As previously noted, ceramic tends to chip or break easily. Thus, any durability gained through its hardness is easily lost through lack of ductility. Also, because cutting tools made of ceramic cannot be used to cut a number of items, such as for cutting frozen foods and bones, a consumer typically has a duplicate set of steel knives for such tasks. Further, although inert ceramic surfaces include an anti-bacterial advantage, since it is recommended that ceramic cutting tools are only used on wood cutting boards, which are notoriously germ infested, any such advantages are essentially lost.

Corrosion, Abrasion, Chipping, and Folding edge are four main mechanisms by which steel blades lose their cutting ability, with the largest contributing factor being corrosion. Carbon steel has minimal corrosion resistance. Even a thin layer of corrosion on a surface causes the top layer to rust (Iron Oxide), which can easily be removed. Abrasion via food products and/or contact with a cutting board, for example, easily removes this oxide layer, thus exposing the next layer to repeat the corrosion and abrasion cycle. Further, since cutting tools like kitchen knives are regularly exposed to moisture and salt, the durability of blades made of steel is significantly less than what is represented by the initial surface hardness. Although carbon Steel has 4-6 GPa hardness, the oxide layer has a fraction of steel's durability, and can even be removed by wiping with a sponge.

Accordingly, keeping such factors in mind, one can conclude that an ideal blade material has three properties: Hardness of approximately 20 GPa to approximately 30 GPa (both inclusive), to provide maximum wear resistance; Ductility in a similar range as that of carbon steel, to minimize chipping and breakage; and Corrosion Resistance is similar to that of ceramic or stainless steel, to blunt the oxidation of a surface and subsequent softening of the surface.

Amorphous alloy materials have these three properties. An amorphous alloy material has a combination of a ductile base and a hard surface which transforms itself to an amorphous layer with extreme corrosion resistance and wear resistance.

The cutting tool may be a knife or scalpel, for example. The cutting tool has a body portion having a blade portion with an edge area that is sharp (also referred to as a “sharp edge” or “sharp edge area”). In accordance with an embodiment, the blade portion is formed from a metal or a ceramic, and the sharp edge includes an amorphous alloy material in which diamond particles are embedded.

In accordance with an embodiment, the sharp edge area includes at least 50% amorphous alloy material. In another embodiment, the sharp edge area includes at least 75% amorphous alloy material.

In one embodiment, the amorphous alloy material on or in the edge area includes a composite material having 50% by volume of amorphous material.

In accordance with another embodiment, the sharp edge area is essentially formed from an amorphous alloy in the edge area and fused to the material of the blade portion.

In accordance with an embodiment, the thickness of the transformed layer to amorphous structure thickness of the amorphous alloy material provided on the edge is between at least approximately 200 micrometers (microns) and approximately 5 microns. In one embodiment, the amorphous surface layer is approximately 200 to 300 microns thick. In accordance with another embodiment, the thickness of the amorphous alloy provided on or in the edge area is up to 500 microns of amorphous transformed layer thickness.

In one embodiment, the amorphous material is a nanocrystalline material. In an embodiment, the amorphous alloy has an elastic limit up to 2%.

In one embodiment, the amorphous alloy used on the edge of the blade has a mix of chrome borides in steel matrix.

In an embodiment, the amorphous alloy material of the sharp edge area of the cutting tool as disclosed herein comprises a mixture having approximately 20% to approximately 50% by weight of chromium therein.

In an embodiment, the amorphous alloy material of the sharp edge area of the cutting tool as disclosed herein comprises a mixture having approximately 30% to approximately 50% by weight of iron therein.

In an embodiment, the amorphous alloy material of the sharp edge area of the cutting tool as disclosed herein comprises a mixture having approximately 30% to approximately 60% by weight of zirconium therein.

Any of the above compositions of amorphous alloy material may be formed and may be fused to the edge of the blade, for example. The following are additional examples of compositions of amorphous material that may be used on or in the sharp edge of the blade in accordance with embodiments. Note that the percentages in the below examples refer to weight percentages (not atomic percentages).

In one embodiment, the amorphous alloy of the sharp edge includes the following mixture: from approximately 25 to 27% by weight of chromium, from approximately 2 to 2.2% by weight of boron, from approximately 16 to 18% by weight of molybdenum, from approximately 2 to 2.5% by weight of carbon and the remaining percentage by weight being iron, such that the total weight of the components are selected to total 100%. The blade portion may include casted or molded metal or ceramic.

In another embodiment, the amorphous alloy of the sharp edge includes the following mixture: from approximately 43 to 46% by weight of chromium, from approximately 1.5 to 2.5% by weight of silicon, from approximately 5.5 to 6.5% by weight of boron, and the remaining percentage by weight being iron, such that the total weight of the components are selected to total 100%. The blade portion may include casted or molded metal or ceramic.

In yet another embodiment, the amorphous alloy of the sharp edge includes the following mixture: wherein the amorphous alloy comprises the following mixture: approximately 11% of titanium, approximately 13% copper, approximately 10% nickel, approximately 3.5% beryllium, and the remaining percentage by weight being zirconium, such that the total weight of the components are selected to total 100%. The blade portion may include casted or molded metal or ceramic.

In still yet another embodiment, the amorphous alloy of the sharp edge includes the following mixture: wherein the amorphous alloy comprises the following mixture: from approximately 3.5 to 11% by weight of titanium, from approximately 13 to 15% by weight of copper, from approximately 10 to 12% by weight of nickel, approximately 2 to 4% by weight of X, and the remaining percentage by weight being zirconium, such that the total weight of the components are selected to total 100%, wherein X comprises: beryllium, aluminum, or a mixture thereof. The blade portion may include casted or molded metal or ceramic. In one embodiment, X comprises a ratio of aluminum to beryllium that is 2.5:1.

In another embodiment, the amorphous alloy of the sharp edge includes the following mixture: approximately 5% by weight of titanium, approximately 15% by weight of copper, approximately 11% by weight of nickel, approximately 1% by weight of beryllium and approximately 2.5% by weight of aluminum, and the remaining percentage by weight being zirconium, such that the total weight of the components are selected to total 100. The blade portion may include casted or molded metal or ceramic.

In yet another embodiment, the amorphous alloy of the sharp edge includes the following mixture: approximately 11% by weight of titanium, approximately 13% by weight of copper, approximately 10% by weight of nickel, approximately 3.5% by weight of beryllium, and the remaining percentage by weight being zirconium, such that the total weight of the components are selected to total 100. The blade portion may include casted or molded metal or ceramic.

In another embodiment, the amorphous alloy of the sharp edge includes the following mixture: approximately 3.5% by weight of titanium, approximately 15% by weight of copper, approximately 12% by weight of nickel, approximately 3.5% by weight of aluminum, and the remaining percentage by weight being zirconium, such that the total weight of the components are selected to total 100. The blade portion may include casted or molded metal or ceramic.

In addition, in those cases in which a handle is formed on or attached to the body portion of the cutting tool, materials such as plastic, wood, etc., may be used to form the handle. The handle may be positioned anywhere on the body of the cutting tool such that force applied from a user can be transmitted through the handle to the body to the blade and cutting edge of the cutting tool.

The descriptions of the one or more embodiments are for purposes of illustration but are not exhaustive or limiting to the embodiments described herein. Many modifications and variations will be apparent to those of ordinary skill in the art without departing from the scope and spirit of the described embodiments. The terminology used herein best explains the principles of the embodiments, the practical application and/or technical improvement over technologies found in the marketplace, and/or to enable others of ordinary skill in the art to understand the embodiments described herein.

### INCORPORATION BY REFERENCE

All references, including granted patents and patent application publications, referred herein are incorporated herein by reference in their entirety.

U.S. Application Publication US20180029241A1, titled “Method of forming cutting tools with amorphous alloys on an edge thereof”

U.S. Application Publication U.S. Pat. No. 5,866,254A, titled “Amorphous metal/reinforcement composite material”

1-52. (canceled)

53. A device, comprising:
a base material;
an amorphous alloy forming an amorphous alloy matrix layer; and
a plurality of diamond particles embedded in the amorphous alloy matrix layer forming a cutting edge, wherein the amorphous alloy matrix layer bonds the plurality of diamond particles and the base material; and
wherein the amorphous alloy matrix layer is at least 300 microns in thickness.

54. The device of claim 53, wherein the device is operable as a cutting tool; and wherein the cutting tool is a knife.

55. The device of claim 53, wherein the plurality of diamond particles is pre-sharpened, and wherein the plurality of diamond particles is of a size ranging from 0.002 mm to 0.02 mm.

56. (canceled)

57. (canceled)

58. The device of claim 53, wherein the base material comprises at least one of steel, aluminum, and an alloy.

59. The device of claim 53, wherein the plurality of diamond particles protrudes above the amorphous alloy matrix layer to form a serrated end of the cutting edge.

60. The device of claim 53, wherein the plurality of diamond particles is arranged in a predetermined pattern on the amorphous alloy matrix layer.

61. The device of claim 60, wherein the predetermined pattern comprises a position and orientation of an edge of each diamond particle of the plurality of diamond particles and a separation between any two diamond particles of the plurality of diamond particles.

62. The device of claim 53, wherein the amorphous alloy has an elastic limit up to 2%.

63. The device of claim 53, wherein the amorphous alloy comprises iron based amorphous ribbons, and wherein the iron based amorphous ribbons comprises at least one of,
iron in a first range of 84-100%, silicon in a second range of 0-10%, boron in a third range of 0-5%, and manganese in a fourth range of 0-2%; and
iron in a fifth range of 0-100%, cobalt in a sixth range of 0-85%, Nickel in a seventh range of 0-50%, silicon in an eighth range of 0-10%, molybdenum in a ninth range of 0-8%, boron in a tenth range of 0-5%, and manganese in an eleventh range of 0-2%.

64. The device of claim 53, wherein the amorphous alloy has an elastic strain limit of at least 1.5% selected from (Zr,Ti)ₐ(Ni,Cu,Fe)_{b}(Be,Al,Si,B)_{c} wherein a=30-75; b=5-60 & c=0-50 atomic percentages; (Zr,Ti)ₐ(Ni,Cu)_{b}(Be)_{c} wherein a=40-75; b=5-50; & c=5-50 in atomic percentages; (Zr,Ti)ₐ(Ni,Cu) (Be)_{c} wherein a=40-65; b=7.5-35; & c=10-37.5 in atomic percentages; and (Zr)ₐ(Nb,Ti)_{b}(Ni,Cu)_{c}(Al)^{d} and wherein a=45-65; b=0-10; c=20-40; and d=7.5-15.

65. The device of claim 53, wherein the amorphous alloy comprises a material that is a Zr-based, a Ti-based, a Zr—Ti-based, an Fe-based, or combinations thereof.

66. The device of claim 53, wherein the amorphous alloy is at least substantially free of Be; and wherein the amorphous alloy further comprises a plurality of crystalline precipitates.

67. The device of claim 53, wherein the amorphous alloy comprises one of silica and silica-based glass sheets.

68. The device of claim 53, wherein an amorphous content of the amorphous alloy is more than 50% by volume.

69. The device of claim 53, wherein an amorphous content of the amorphous alloy is more than 75% by volume.

70. The device of claim 53, wherein an amorphous content of the amorphous alloy is more than 99% by volume.

71. The device of claim 53, wherein the amorphous alloy comprises a bulk metallic glass.

72. The device of claim 53, wherein the amorphous alloy comprises a nanocrystalline material.

73. The device of claim 54, wherein the cutting tool further comprises a handle secured to the cutting tool, wherein the handle is made from a non-slip material comprising textured polymer.

74. The device of claim 73, wherein the handle is foldable allowing a blade portion of the cutting tool to be securely enclosed within the handle.
